(19) United States
(12) Patent Application Publication
(10) Pub. No.: US 2025/0108737 A1
(43) Pub. Date: Apr. 3, 2025

(54) CONVERTIBLE SEAT ASSEMBLY

(71) Applicant: Winnebago Industries, Inc., Eden Prairie, MN (US)

(72) Inventors: Amelia Sheckler, Forest City, IA (US); Michael Berns, Garner, IA (US); Ethan Cheville, Britt, IA (US); Matthew Haugen, Feritle, IA (US); Travis Weber, Plymouth, IA (US)

(21) Appl. No.: 18/375,706

(22) Filed: Oct. 2, 2023

(51) Int. Cl. B60N 2/30; B60N 2/02; B60N 2/06; B60N 2/90; B60P 3/32; B60R 22/18; B60R 22/24

(52) U.S. Cl. CPC B60N 2/3093; B60N 2/06; B60N 2/3025; B60N 2/3059; B60N 2/90; B60N 2/919; B60P 3/32; B60R 22/24; B60N 2002/0288; B60N 2002/952; B60N 2002/981; B60R 2022/1806

(57) ABSTRACT

A convertible seat assembly is operable to transition between a collapsed position and an expanded position. The convertible seat assembly includes a fixed seat and a sliding seat. The sliding seat may be independently moveable with respect to the fixed seat. The convertible seat assembly may be coupled to a seat belt assembly, which includes a first seat belt operable to releasably couple to the fixed seat and a second seat belt operable to releasably couple to the sliding seat.

### SUMMARY

In certain embodiments of the present disclosure, a recreational vehicle includes a body with a cab area and a living space area. A convertible seat assembly is positioned in the living space area and transitions between a collapsed position and an expanded position. The convertible seat assembly includes a fixed seat, a sliding seat independently moveable with respect to the fixed seat, and a seat belt assembly. The seat belt assembly is coupled to the convertible seat assembly and includes a first seat belt releasably coupled to the fixed seat and a second seat belt releasably coupled to the sliding seat.

In a variation thereof, the fixed seat and the sliding seat collapse to form a single seat in the collapsed position. In another variation thereof, the sliding seat further includes a seat back portion and a seat bottom portion which move independently from each other. In yet another variation thereof, the recreational vehicle has a first alarm component on the fixed seat, a second alarm component on the sliding seat, and a third alarm component on a side wall adjacent to the sliding seat. An alarm signal is generated when the second alarm component is not in communication with at least one of the first alarm component or the third alarm component. In yet another variation thereof, the convertible seat assembly transitions to a further expanded position to define a second sliding seat. The second sliding seat includes a second plurality of sliding slats adjacent to the sliding seat when the convertible seat assembly is in the further expanded position. In yet another variation thereof, the fixed seat includes a plurality of fixed slats and the sliding seat includes a plurality of sliding slats. The plurality of sliding slats slide adjacent to the plurality of fixed slats to transition the convertible seat assembly between the collapsed position and the expanded position. In yet another variation thereof, the recreational vehicle includes a cushion assembly coupled to the convertible seat assembly. In yet another variation thereof, the collapsible seat assembly has a collapsed width in the collapsed position and an overall expanded width in the expanded position. The expanded overall width is between 90% to 110% of the collapsed width.

In another variation thereof, the first seat belt and the second seat belt are both three-point seat belts. In a further variation thereof, a latch of the second seat belt releasably couples to a second buckle in a side-wall of the living space area to establish three-point contact.

In yet another variation thereof, the sliding seat is coupled to at least one of a floor of the living space area or a side wall of the living space area when the convertible seat assembly is in the expanded position. In another variation thereof, the sliding seat is coupled to the living space area via at least one release pin and the release pin can transition between a locked position and an unlocked position. In another variation thereof, the sliding seat further includes a seat back portion and a seat bottom portion and the release pins are positioned on both the seat back portion and the seat bottom portion. In yet another variation thereof, the release pin includes a lock component to transition the release pin to the locked position. The lock component includes a body extending through a frame of the sliding seat and into a housing positioned in the recreational vehicle. In yet another variation thereof, the release pin includes a release mechanism to transition the release pin to the unlocked position, the release mechanism including a spring.

In certain embodiments of the present disclosure, a convertible seat assembly is operable to transition between a collapsed position and an expanded position. The convertible seat assembly includes a fixed seat including a plurality of fixed slats, a sliding seat including a plurality of sliding slats, and a seat belt buckle positioned on an end of the fixed seat operable to receive a first three-point seat belt. The sliding seat is adjacent to the fixed seat when the convertible seat assembly is in the expanded position. The plurality of sliding slats are operable to slide adjacent to the plurality of fixed slats to transition the convertible seat assembly between the collapsed position and the expanded position.

In a variation thereof, the fixed seat and the sliding seat collapse to form a single seat in the collapsed position. In another variation thereof, the convertible seat assembly includes a second seat belt buckle positioned on an end of the sliding seat operable to receive a second three-point seat belt. In yet another variation thereof, the sliding seat further includes a seat back portion and a seat bottom portion that can move independently from each other. In yet another variation thereof, the convertible seat assembly is operable to transition to a further expanded position to define a second sliding seat, the second sliding seat including a second plurality of sliding slats. The second sliding seat is adjacent to the sliding seat when the convertible seat assembly is in the further expanded position.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 shows a top-down view of a schematic floor plan of the recreational vehicle of FIG. 1, in accordance with certain embodiments of the present disclosure.

FIG. 3 shows a convertible seat assembly in a collapsed position, in accordance with certain embodiments of the present disclosure.

FIG. 4 shows an intermediate position of the convertible seat assembly of FIG. 3, in accordance with certain embodiments of the present disclosure.

FIG. 5 shows an expanded position of the convertible seat assembly of FIG. 3, in accordance with certain embodiments of the present disclosure.

FIGS. 6A and 6B show the convertible seat assembly of FIG. 3 coupled to a seat belt assembly, in accordance with certain embodiments of the present disclosure.

FIGS. 7A and 7B show the convertible seat assembly of FIG. 5 coupled to the seat belt assembly, in accordance with certain embodiments of the present disclosure.

FIGS. 8A, 8B, and 8C show the convertible seat assembly coupled the recreational vehicle via release pins, in accordance with certain embodiments of the present disclosure.

FIGS. 9A and 9B show an alarm system for the convertible seat assembly, in accordance with certain embodiments of the present disclosure.

FIG. 10 shows the convertible seat assembly with a cushion assembly, in accordance with certain embodiments of the present disclosure.

FIG. 11 shows a car seat and a bucket seat coupled to the convertible seat assembly, in accordance with certain embodiments of the present disclosure.

FIGS. 12A-12C show a convertible seat assembly in a further expanded position defining a second sliding seat, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

The present disclosure describes convertible seat assemblies that provide various benefits when used with vehicles such as recreational vehicles. As one example, certain embodiments of the present disclosure allow a convertible seat assembly to transition from a collapsed position defining one seat to an expanded position defining at least two seats, which allows the seating of the recreational vehicle to be increased without reducing the living space area of the recreational vehicle. As another example, certain embodiments of the present disclosure include a seat belt assembly including at least two, three-point seat belts such that each seat of the expanded seating may couple to a three-point seat belt for use when the recreational vehicle is in motion. As another example, certain embodiments of the present disclosure allow for the convertible seat assembly to couple to the recreational vehicle (e.g., at a side wall or on the floor) to lock the convertible seat assembly into place when in the expanded position to reduce movement of the seating when the recreational vehicle is in motion.

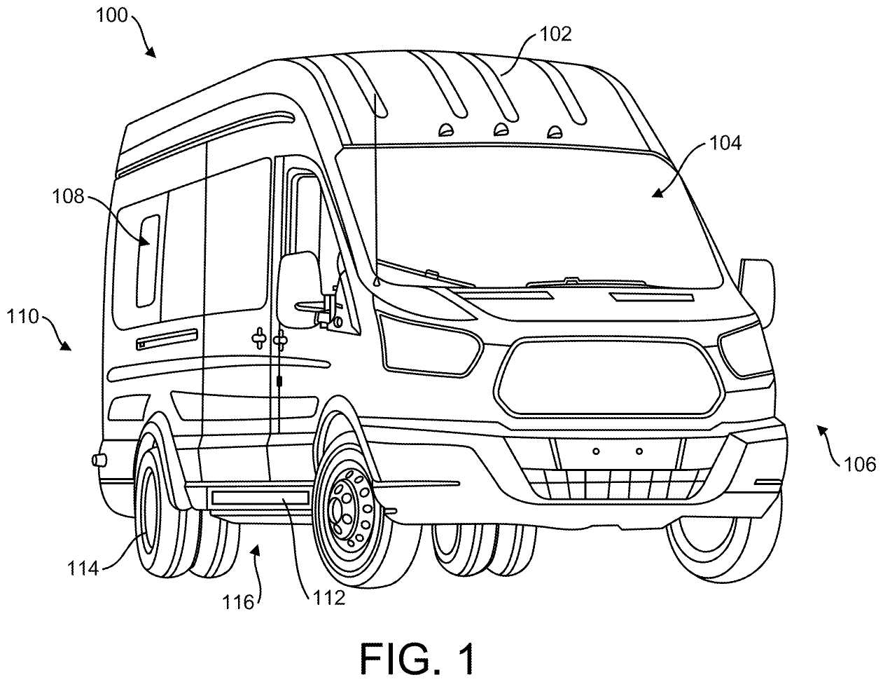

FIG. 1 shows a recreational vehicle 100 having a body 102 that houses a cab area 104 at a front end 106 of the recreational vehicle 100 and a living space area 108 positioned between the cab area 104 and a rear end 110 of the recreational vehicle 100. The recreational vehicle 100 can include one or more power sources (represented by block 112 for simplicity of illustration) that are operably coupled to (e.g., via a transmission, shafts) front and/or rear axles and that provide the energy to rotate the axle(s) and/or wheels 114 and therefore propel the recreational vehicle 100. The power source 112 can include an engine (e.g., gas engine or diesel engine), rechargeable batteries, fuel cell, or a combination (e.g., hybrid) of an engine and rechargeable batteries, etc.

In embodiments where the recreational vehicle 100 is at least partially powered and propelled by electricity created by batteries 112, the batteries 112 can be distributed throughout the chassis of the recreational vehicle 100. For example, the batteries 112 may be positioned below a floor of the living space area 108 of the recreational vehicle 100. In certain embodiments, the batteries 112 power electric motors that rotate one or more of the wheels 114 (e.g., by rotating the axles or by directly rotating the wheels).

Although FIG. 1 shows what is typically referred to as a Class B recreational vehicle or a camper van, embodiments of the present disclosure can be used in other types of motorized recreational vehicles (e.g., Class A recreational vehicles, Class C recreational vehicles, and the like), non-motorized types of recreational vehicles (e.g., 5th wheel trailers, travel trailers, and the like), and marine recreational vehicles.

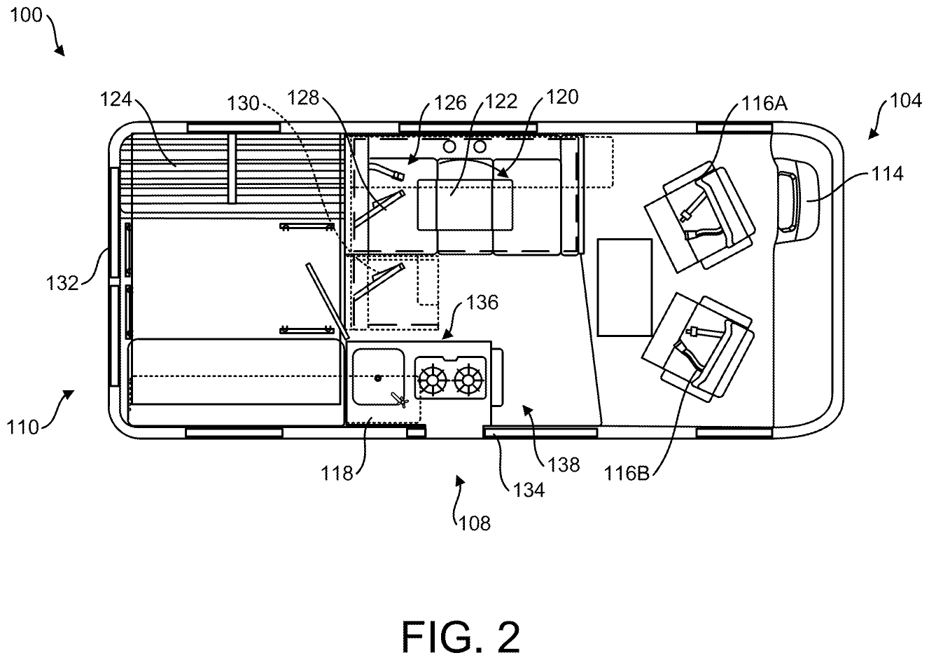

FIG. 2 shows a top-down view of a schematic floorplan of the recreational vehicle 100 of FIG. 1. The floorplan is just one example of how embodiments of the present disclosure can be used with recreational vehicles such as the recreational vehicle 100.

As shown in FIG. 2, the recreational vehicle 100 can include a driver's seat 116A and a passenger's seat 116B located in the cab area 104. The driver's seat 116A and the passenger's seat 116B can rotate to face various directions (e.g., forward when driving, aft when parked, and therebetween). The living space area 108 of the recreational vehicle 100 can also include a kitchen area 118, additional passenger seating 120, a dining area 122, a wet bath area, and a bed 124. The additional passenger seating includes, but is not limited to, a convertible seat assembly 126. The convertible seat assembly 126 may include a fixed seat 128 and at least one sliding seat 130. The recreational vehicle 100 may also include a rear door 132 at the rear end 110 and a side door 134 in the living space area. The rear door 132 may include, but is not limited to, a single door or a double door. The rear door 132 may also include a window. The side door 134 may include, but is not limited to, a sliding door.

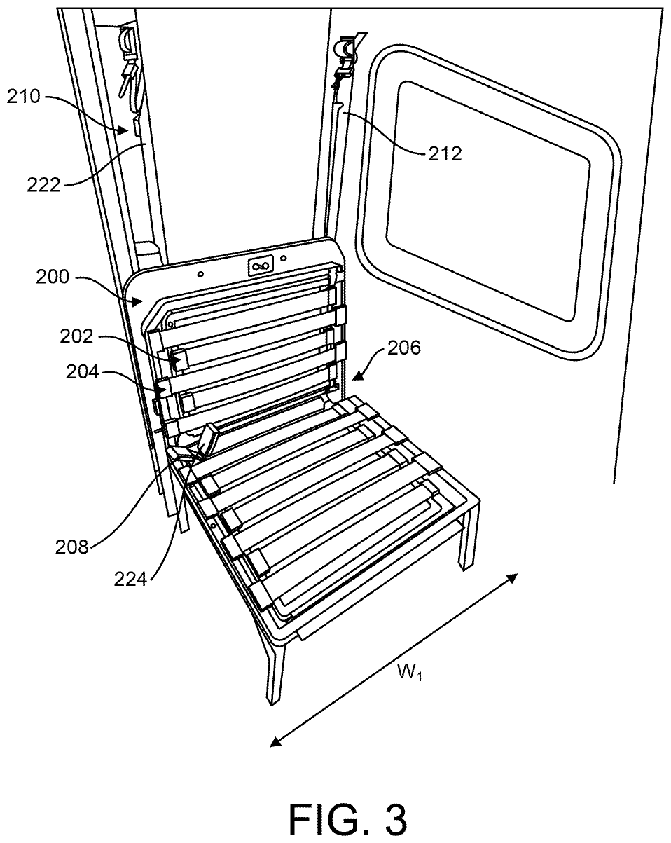

FIG. 3 shows a convertible seat assembly 200 in a collapsed position. The convertible seat assembly 200 may be substantially similar to the convertible seat assembly 126 of FIG. 2. The convertible seat assembly 200 may be positioned in the living space area 108 of the recreational vehicle 100. For example, the convertible seat assembly 200 may be positioned adjacent to or within the dining area 122, as shown in FIG. 2. In other examples, the convertible seat assembly 200 may be positioned adjacent to the rear door 132, the side door 134, or the kitchen area 118 of the recreational vehicle 100.

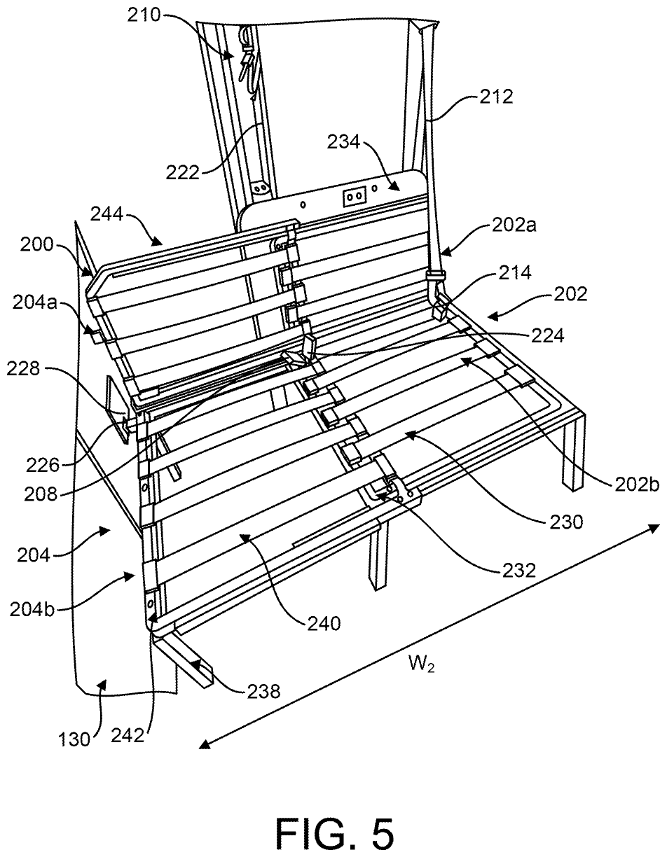

Further to FIG. 3, the convertible seat assembly 200 includes a fixed seat 202 and a sliding seat 204 (e.g., as shown in FIG. 5). As shown in FIG. 3, in the collapsed position, the fixed seat 202 and the sliding seat 204 form a single seat 206. In the collapsed position, the single seat 206 may correspond to the position of the fixed seat 202 when the convertible seat assembly 200 is in the expanded position (e.g., as shown in FIG. 5). The single seat 206 may include a first seat belt buckle 208 positioned on an end of the single seat 206.

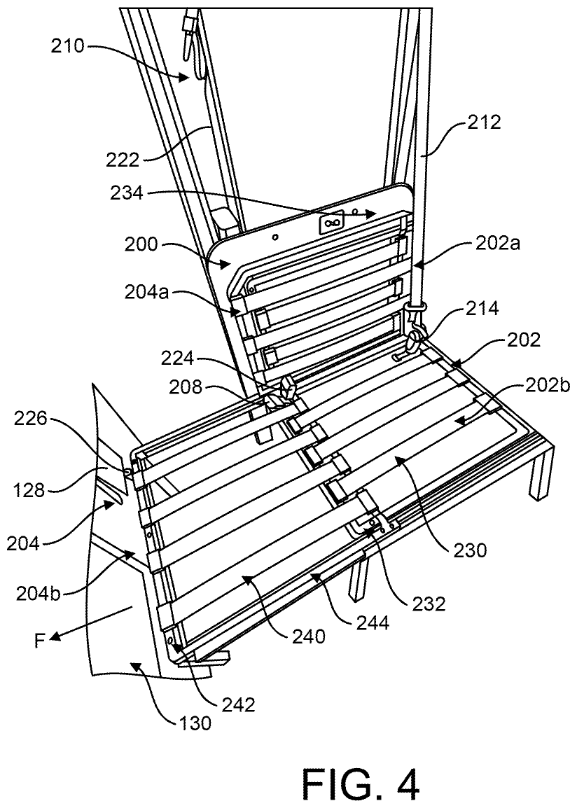

FIG. 4 shows the convertible seat assembly 200 in an intermediate position between the collapsed position (e.g., as shown in FIG. 3) and an expanded position (e.g., as shown in FIG. 5). The convertible seat assembly 200 is operable to transition between the collapsed position and the expanded position. In some examples, the convertible seat assembly 200 transitions to the expanded position by moving the sliding seat 204 away from the fixed seat 202 such that the sliding seat 204 and the fixed seat 202 are positioned adjacent to each other in the expanded position (e.g., as shown in FIG. 5). The sliding seat 204 may be independently moveable with respect to the fixed seat 202. In some examples, the sliding seat 204 includes a sliding seat back portion 204a and a sliding seat bottom portion 204b that are operable to move independently from each other to define the intermediate position. In the intermediate position, either the sliding seat back portion 204a or the sliding seat bottom portion 204b may be moved first toward the expanded position. In other examples, the sliding seat back portion 204a and the sliding seat bottom portion 204b may form a single unit such that they transition to the expanded position together.

FIG. 5 shows the convertible seat assembly 200 in the expanded position. In the expanded position, the convertible seat assembly 200 defines at least two seats, the fixed seat 202 and the sliding seat 204 where the fixed seat 202 and the sliding seat 204 may be positioned adjacent to each other such that one person can sit on the fixed seat 202 while another person can sit on the sliding seat 204.

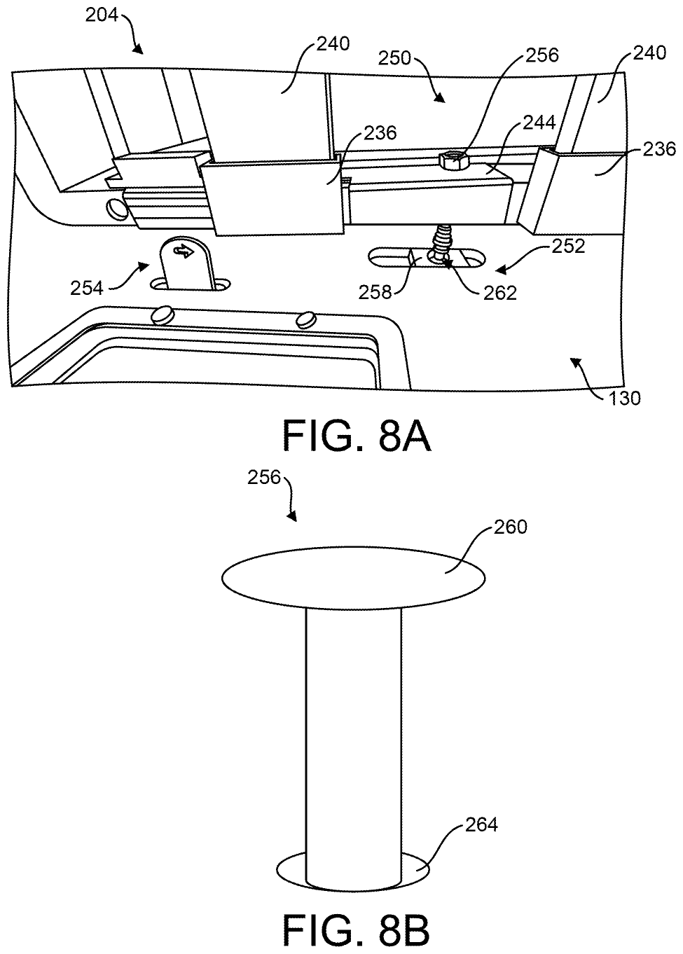

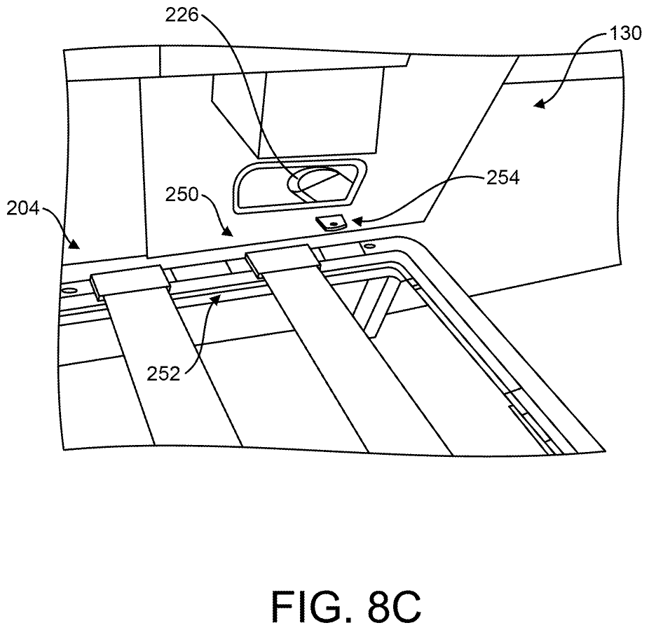

In some examples, the convertible seat assembly 200 is transitioned between the collapsed and expanded positions by sliding the sliding seat 204 in a direction away from the fixed seat 202. In this example, the fixed seat 202 includes a plurality of fixed slats 230. The plurality of fixed slats 230 may include rectilinear slats (e.g., rectangular-shaped slats). Each of the fixed slats in the plurality of fixed slats 230 may be made of a composite material and/or wood, including, but not limited to oak. Each of the fixed slats in the plurality of fixed slats 230 may be made of the same material, or may be made of different materials. Each of the fixed slats in the plurality of fixed slats 230 are coupled to a set of fixed slat posts 232, which are located on either side of the fixed slats. In some examples, the fixed slat posts 232 corresponds to a fixed seat frame 234 of the fixed seat 202. Each fixed slat of the plurality of fixed slats 230 may be coupled to the fixed slat posts 232 on both sides of the fixed slat and along a short end of the slat (e.g., the short end of the rectangular shape). Each fixed slat of the plurality of fixed slats 230 may be coupled to each other via the fixed slat posts 232. The fixed slat posts 232 may be made of metal, including but not limited to, aluminum. The fixed slat posts 232 may further include housings 236 (e.g., as shown in FIG. 8A) for coupling to each slat of the plurality of slats 236. The housings 236 may be sized to fit the short end of each fixed slat in the plurality of fixed slats 230. The housings 236 may include, but are not limited to, plastic or metal.

Similarly, the sliding seat 204 may include a plurality of sliding slats 240. The plurality of sliding slats 240 may be substantially similar to the plurality of fixed slats 230 and may also include rectilinear slats. Each of the sliding slats of the plurality of sliding slats 240 are coupled to a set of sliding slat posts 242, located on either side of the sliding slat. The sliding slat posts 242 may be substantially similar to the fixed slat posts 232 and may also be part of a sliding frame 244 of the convertible seat assembly 200. The sliding slat positions 242 may also include housings 236 (e.g., as shown in FIG. 8A) for coupling to each sliding slat in the plurality of sliding slats 240.

During the transition from the collapsed position of FIG. 3 to either the intermediate position of FIG. 4 or the expanded position of FIG. 5, the plurality of sliding slats 230 are operable to slide adjacent to the plurality of fixed slats 240 to change a length of the convertible seat assembly 200. The fixed seat 202 may be anchored to a support (e.g., a floor or another part of the recreational vehicle 100) such that it does not slide. Due to the inclusion of rectilinear slats, the plurality of sliding slats 240 may move in a substantially straight line. The plurality of sliding slats 240 may start sliding upon a force F being applied to the sliding seat 204. In some embodiments, the force F may come from a user pulling the sliding seat 204 outwardly relative to the fixed seat 202 without mechanical assistance (e.g., wheels). In other embodiments, the force F may be facilitated by wheels or a rolling support located below the sliding seat 204 (not shown). The force F may be applied linearly, or in the same plane as the fixed seat 202 to avoid damage to the rectilinear slats. The sliding seat 204 and the fixed seat 202 may be engaged in a friction fit. The friction fit may be such that more force F is needed to move the sliding seat 204 out of the collapsed position (see, e.g., FIG. 3) than to move the sliding seat 204 out of the intermediate position (see, e.g., FIG. 4) and toward the expanded position (see, e.g., FIG. 5). This feature may assist in preventing the sliding seat 204 from moving while the recreational vehicle 100 is in motion (e.g., driving).

In the collapsed position of FIG. 3, the plurality of fixed stats 230 and the plurality of sliding slats 240 are positioned alongside each other over a width of the convertible seat assembly 200. The plurality of fixed slats 230 and the plurality of sliding slats 240 are positioned alongside each other along substantially the whole length of the slats. In the collapsed position, the overall width of the convertible seat assembly 200 is minimized and defines a collapsed width W1. In the expanded position of FIG. 5, the overlap between the plurality of fixed slats 230 and the plurality of sliding slats 240 is reduced such that the overall width of the convertible seat assembly 200 is maximized and defines an extended width W2, which is longer than the collapsed width W1. In some embodiments, the extended width W2 is approximately double the collapsed width W1, or the extended width W2 is between about 90% to about 110% or 90% to 98% larger than the collapsed width W1.

In certain embodiments, the convertible seat assembly 200 utilizes the fixed seat 202 and a rotatable seat (instead of the sliding seat 204). To transition between the collapsed position and the expanded position, the rotatable seat is rotated (e.g., approximately 180 degrees) such that multiple seats are available for use in the expanded position and only a single seat is available for use in the collapsed position.

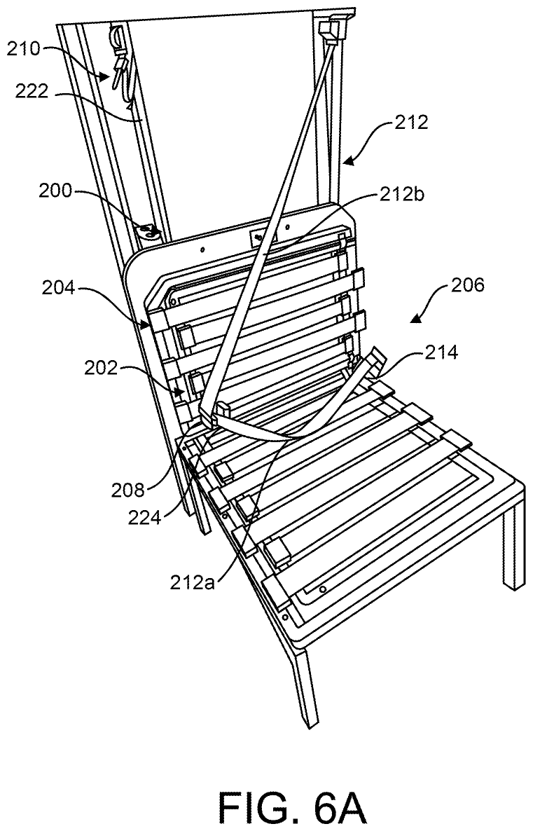

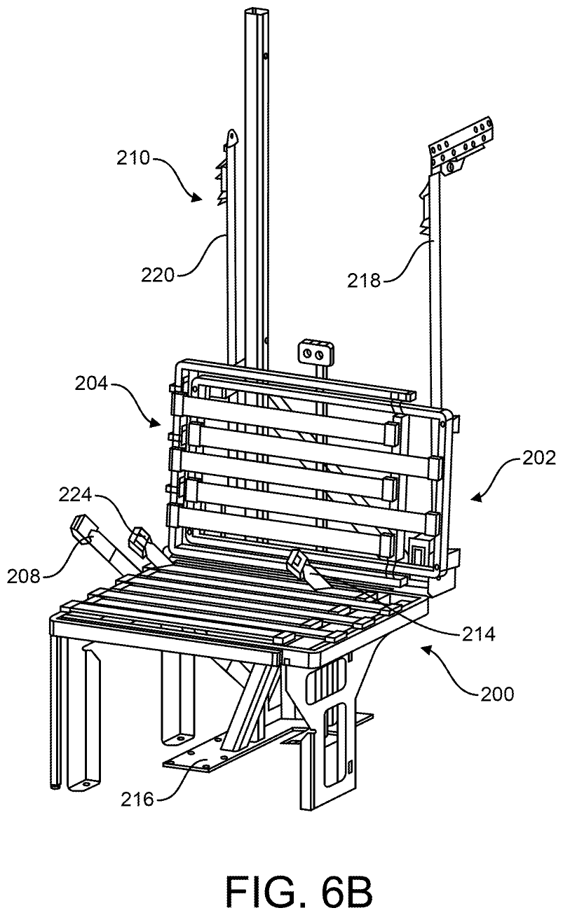

Turning to FIG. 6A, the convertible seat assembly 200 may include a first seat belt buckle 208 positioned on an end of the single seat 206 in the collapsed position. The first seat belt buckle 208 may be operable to releasably couple with a seat belt assembly 210 of the recreational vehicle 100. The seat belt assembly 210 may be positioned proximate to the convertible seat assembly 200 in the living space area 208. The seat belt assembly 210 may be integrated into a wall of the recreational vehicle 100 or hidden behind other structures in the recreational vehicle 100. The seat belt assembly 210 may include a first seat belt 212 operable to releasably coupled to the single seat 206 at the first seat belt buckle 208. The first seat belt 212 may include a lap belt 212a and a sash belt 212b in a Y-shape arrangement. To establish three-point contact, the seat belt assembly 210 may also include a first seat belt anchor 214 positioned on an opposite end of the convertible seat assembly 200 from the first seat belt buckle 208. The first seat belt anchor 214 may also be operable to releasably couple to the first seat belt 212 to establish three points of contact such that the first seat belt 212 is a three-point seat belt.

FIG. 6B illustrates the seat belt assembly 210 and the convertible seat assembly 200 of FIG. 3 isolated from the recreational vehicle 100. The seat belt assembly 210 may include a floor anchor 216 coupled (e.g., welded) into a floor of the recreational vehicle 100. The first seat belt buckle 208 and the first seat belt anchor 214 may extend from the floor anchor 216 toward the convertible seat assembly 200. The convertible seat assembly 200 may also include a first seat belt vertical support 218 that is coupled to (e.g., welded) to a wall of the recreational vehicle 100. The first seat belt vertical support 218 may support the first seat belt 212.

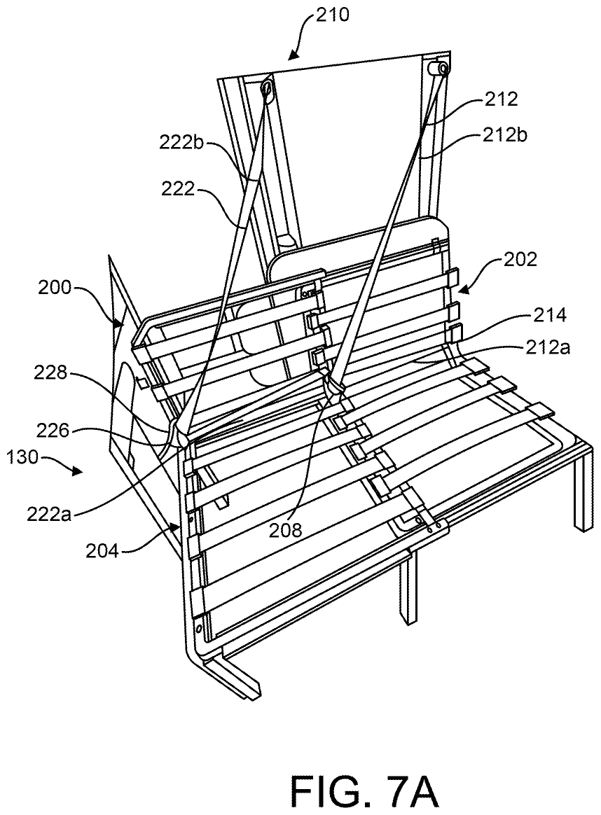

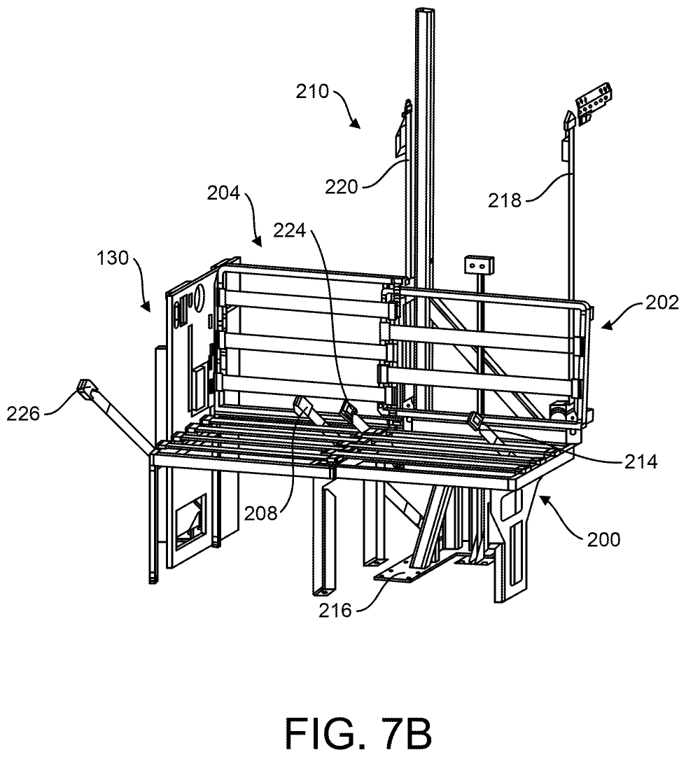

FIG. 7A illustrates the convertible seat assembly 200 coupled to the seat belt assembly 210 when the convertible seat assembly 200 is in the expanded position. In the expanded position, the first seat belt 212 releasably couples to the fixed seat 202 at the first seat belt buckle 208. The first seat belt 212 releasably couples to the fixed seat 202, which may be similar to the first seat belt 212 releasably coupling to the single seat 206 as described with respect to FIGS. 6A-6B. The seat belt assembly 210 may also support a second seat belt 222 that is operable to releasably couple to the sliding seat 204. The second seat belt 222 may include a lap belt 222a and a sash belt 222b in a Y-shape arrangement. To establish three-point contact, the seat belt assembly 210 may also include a second seat belt anchor 224 positioned on an end of the sliding seat 204. The second seat belt anchor 224 may be positioned proximate to or integral with the first seat belt buckle 208. The convertible seat assembly 200 may also include a second seat belt buckle 226 positioned on or proximate to an end of the sliding seat 204, opposite to the end that includes the second seat belt anchor 224. The second seat belt 222 may also be operable to releasably couple to both the second seat belt buckle 226 and a second seat belt anchor 224 to establish three points of contact such that the second seat belt 222 is a three-point seat belt. In some embodiments, the second seat buckle 226 may be positioned within a side wall 136 of the recreational vehicle 100. The side wall 136 may be positioned in the kitchen area 118 (e.g., as shown in FIG. 2), or another side wall of the recreational vehicle 100. The second seat buckle 226 positioned within the side wall 136 may establish three point contact for the second seat belt 222. The second seat buckle 226 may be hidden within the side wall, or include a covering 228, such that the second seat buckle 226 is out of sight when not in use. In some embodiments, the covering 228 includes, but is not limited to, a zipper-sealed covering.

FIG. 7B illustrates the seat belt assembly 210 and the convertible seat assembly 200 of FIG. 5 isolated from the recreational vehicle 100. Similar to the seat belt assembly 210 discussed with respect to FIG. 6B, the second seat belt anchor 224 may extend from the floor anchor 216. The convertible seat assembly 200 may also include a second seat belt vertical support 220 that is coupled to (e.g., welded) to a wall of the recreational vehicle 100. The second seat belt vertical support 218 may support the second seat belt 222. The second seat buckle 226 positioned within the side wall 136 may be coupled to (e.g., welded) to the side-wall 136 and extend therefrom. In some embodiments, as shown in FIG. 7B, the second seat belt buckle 226 is separated from the seat belt assembly 210, but releasably couples thereto. In other embodiments, the second seat buckle 226 is part of the seat belt assembly 210 similar to the first seat buckle 208. In other embodiments, the seat belt assembly 210 may include a plurality of seat belt assemblies such that the first seat belt 212 and the second seat belt 222 extend from separate seat belt assemblies.

FIGS. 8A and 8C show the convertible seat assembly 200 coupled to the recreational vehicle 100. The convertible seat assembly 200 may be coupled to the recreational vehicle 100 when the convertible seat assembly 200 is in the expanded position. In some embodiments, the convertible seat assembly 200 is coupled to the side wall 136 in the living space area 108 of the recreational vehicle 100. The side wall 136 may be positioned in or near the kitchen area 118, or may be another side wall of the recreational vehicle 100, such that the convertible seat 200 is positioned proximate to the second seat buckle 226. In other embodiments, the convertible seat assembly 200 may be coupled to a floor 138 of the living space 108 of the recreational vehicle 100. The convertible seat assembly 200 may be coupled to the recreational vehicle 100 via one or more release pins 250 positioned on the sliding seat 204. The one or more release pins 250 may be positioned on one or both of the sliding seat back portion 204a and the sliding seat bottom portion 204b of the sliding seat 204.

Each of the one or more release pins 250 may include a lock mechanism 252 and a release mechanism 254, which are operable to transition the one or more release pins 250 between a locked position and an unlocked position. The lock mechanism 252 may include a body 256 and a housing 258. The body 256 may be coupled to the frame 244 of the sliding seat 204 such that the body 256 extends through the frame 244 toward the housing 258. As shown in FIG. 8B, on one end, the body 256 may include a cap 260 to hold the body 256 in place on the sliding seat frame 244. The housing 258 may be built into the recreational vehicle 100 (e.g., built into the side wall 136). The housing 258 may include an opening 262, where the body 256 is operable to extend into the opening 262 to couple to the sliding seat 204 to the recreational vehicle 100. The body 256 may include a notch 264 on one end of the body 256 that is operable to engage with the opening 262 to lock the body 256 to the housing 258. The notch 264 may be sized larger than the opening 262 such that once the notch 264 engages the opening 262, the body 256 is not able to be removed from the opening 262 and the release pin 250 is transitioned to the locked position. In the locked position, the sliding seat 204 is locked to the recreational vehicle 100 and the sliding seat 204 is no longer able to move relative to the fixed seat 202. This may reduce instances of movement of the sliding seat 204 while the recreational vehicle 100 is in motion. To release the sliding seat 204 from the side wall 136, and release the body 256 from the housing 258, the release mechanism 254 is engaged. The release mechanism 254 may include a spring (not shown). The release mechanism 254 may be operable to transition the release pin 250 from the locked position to the unlocked position upon applying a force to the release mechanism 254. The release mechanism 254 may be pushed by a user such that the spring moves the housing 258 to disengage the body 256 from the housing 258 such that the one or more release pins 250 are transitioned to the unlocked position. In some embodiments, the spring of the release mechanism 254 enlarges the opening 262 of the housing 258 to allow the body 256 to be removed. When the one or more release pins 250 are in the unlocked position, the sliding seat 204 is operable to move with respect to the fixed seat 202. In some embodiments, the one or more release pins 250 may be used to lock one or more legs 238 of the sliding seat 204 into a floor 138 of the recreational vehicle 100.

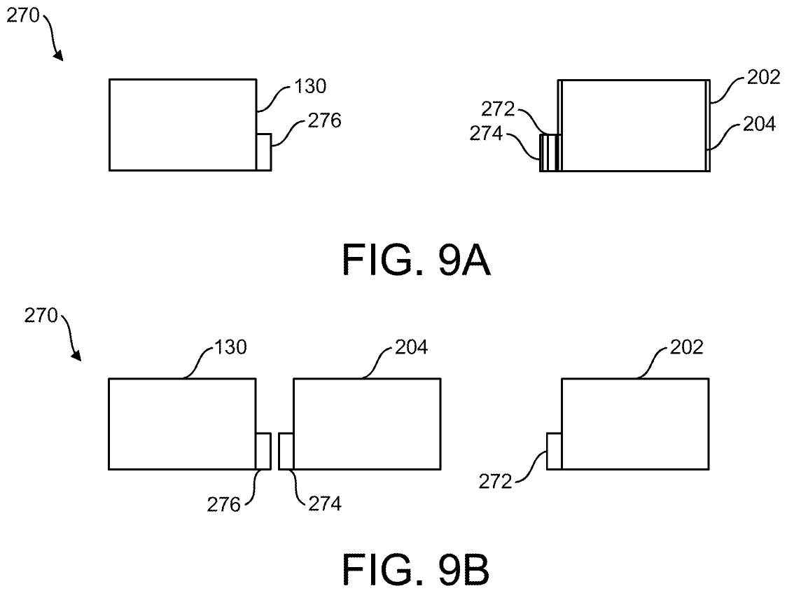

In some embodiments, the convertible seat assembly 200 may further include an alarm system 270 to inform a user that the one or more release pins 250 are not in the locked position when the recreational vehicle 100 is in motion. FIGS. 9A-9B illustrate the alarm system 270 of the convertible seat assembly 200. In some embodiments, the alarm system 270 may have a plurality of alarm components including a first alarm component 272 coupled to the fixed seat 202, a second alarm component 274 coupled to the sliding seat 204, and a third alarm component 276 coupled to the side wall 136 of the recreational vehicle 100. In some embodiments, an alarm signal may be generated when the second alarm component 274 is not in communication with at least one of the first alarm component 272 or the third alarm component 276. When the convertible seat assembly 200 is in the collapsed position, as shown in FIG. 9A, the first alarm component 272 and the second alarm component 274 are in communication such that the alarm signal is not generated. When the convertible seat assembly 200 is in the expanded position, as shown in FIG. 9B, the second alarm component 274 and the third alarm component 276 are in communication. If the sliding seat 204 is coupled to the side wall 136 via the one or more release pins 250 (e.g., as shown in FIGS. 8A-8B), then the second alarm component 274 and the third alarm component 276 stay in communication, even when the recreational vehicle 100 is in motion (e.g., driving), such that the alarm signal is not generated. If the sliding seat 204 is not coupled to the side wall 136, then the second alarm component 274 and the third alarm component 276 may not stay in communication when the recreational vehicle 100 is in motion as the sliding seat 204 may be able to move. In this case, the alarm signal will sound such that an driver is made aware that the sliding seat 204 is not secured. In this case, the operator can stop motion of the recreational vehicle 100 and secure the sliding seat 204 in place. In some embodiments, the alarm signal may be configured to sound only when the recreational vehicle 100 is in motion and not when the recreational vehicle 100 is parked. This allows the operator to transition the convertible seat assembly 200 between the collapsed and expanded positions when parked without the alarm signal sounding.

In some embodiments, the first alarm component 272, the second alarm component 274, and/or the third alarm component 276 include proximity magnets that are in communication when the magnets are close to each other (e.g., not necessarily touching). In other embodiments, the first alarm component 272, the second alarm component 274, and/or the third alarm component 276 include other sensor types that are in communication when coupled or in contact with each other.

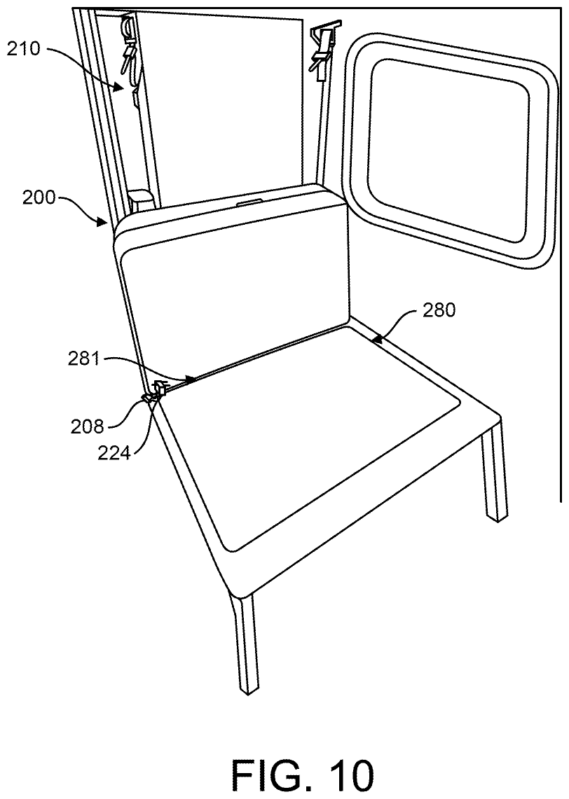

FIG. 10 illustrates the convertible seat assembly 200 with a cushion assembly 280 coupled thereto. The cushion assembly 280 may include a separate fixed seat cushion assembly for the fixed seat 202 and a separate sliding seat cushion assembly for the sliding seat 204. In other embodiments, a single cushion assembly may be coupled to both the fixed seat 202 and the sliding 204. The cushion assembly 280 may include one or more slits 281 that allow any of the first seat buckle 208, first anchor 214, and/or second seat buckle 226 to extend therethrough, which allows the convertible seat assembly 200 to couple to the seat belt assembly 210 while the cushion assembly 280 is in use.

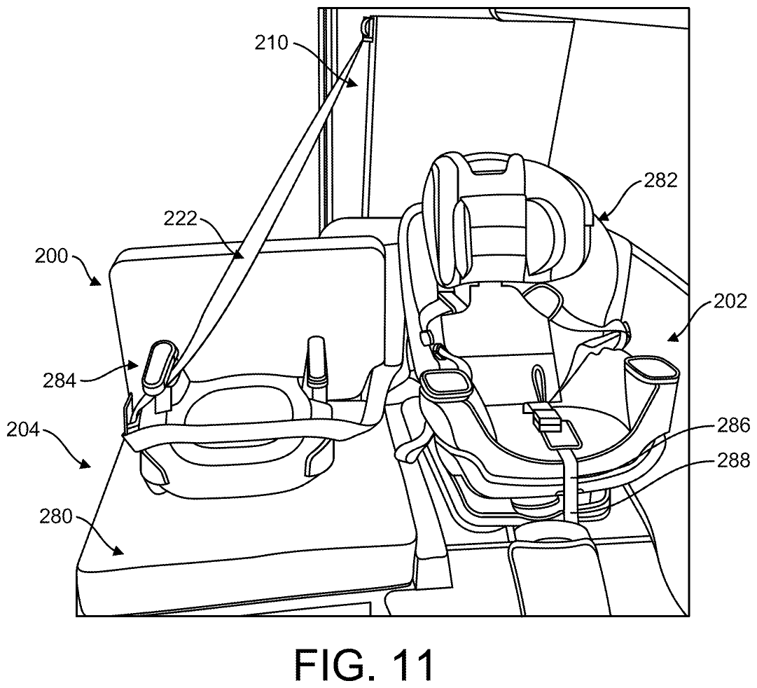

FIG. 11 illustrates the convertible seat assembly 200 adapted for use with an infant car seat 282 and a child bucket seat 284. In some embodiments, the fixed seat 202 may include a connector 286 (e.g., a tether) to hold the infant car seat 282 in place. In other embodiments, the plurality of fixed slats 230 on a seat bottom portion 202a of the fixed seat 202 may be removeable such that the infant car seat 282 can couple onto a fixture 288 to support and secure the infant car seat 282 to the fixed seat 202 in addition to securing the infant car seat 282 with the first seat belt 212. The child bucket seat 284 may be positioned onto either of the fixed seat 202 or the sliding seat 204 and be used with either the first seat belt 212 or second seat belt 222, respectively. The child bucket seat 284 may be placed on top of the cushion assembly 280.

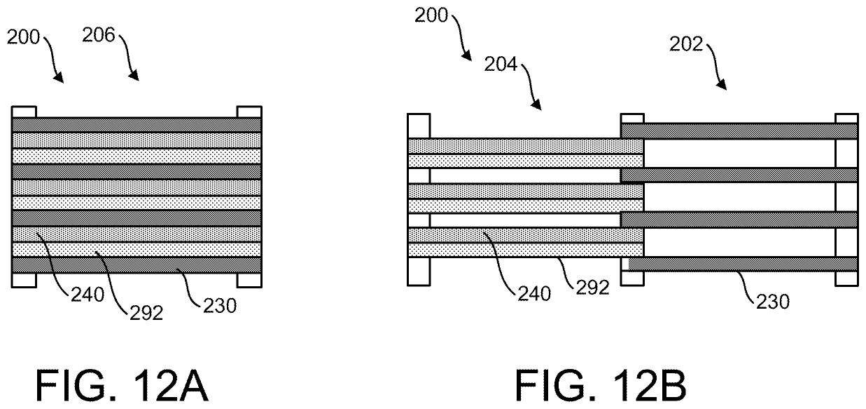

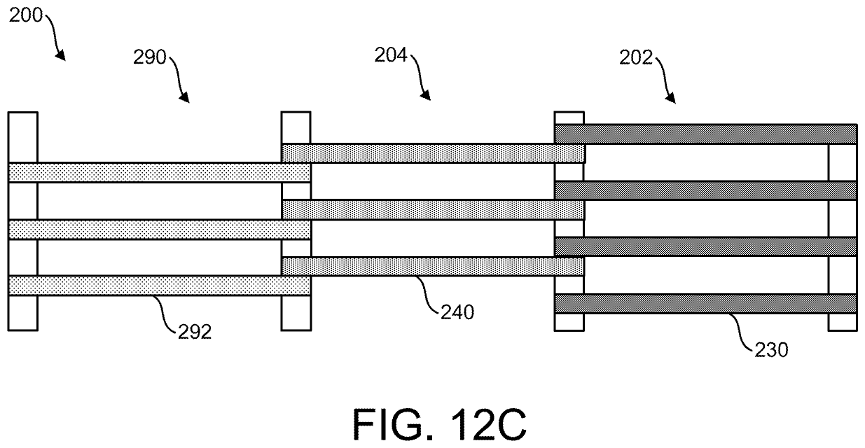

In some embodiments, the expanded position may define more than one sliding seat. FIGS. 12A-12C illustrate the convertible seat assembly 200 transitioning from the collapsed position to a further expanded position to define a second sliding seat 290. FIG. 12A illustrates the convertible seat assembly 200 in the collapsed position in which the single seat 206 is defined. The single seat 206 may be similar to the single seat 206 described with respect to FIG. 3, and may be coupled to the seat belt assembly 210 as described with respect to FIG. 3. FIG. 12B illustrates the convertible seat assembly 200 in the expanded position in which the fixed seat 202 and the sliding seat 204 are defined. FIG. 12C illustrates the convertible seat assembly 200 in the further expanded position. In the further expanded position, the second sliding seat 290 is adjacent to the sliding seat 204, such that the sliding seat 204 is between the fixed seat 202 and the second sliding seat 290. The second sliding seat 290 may be configured similar to the sliding seat 204, as described herein. The second sliding seat 290 may include a second plurality of sliding slats 292, where the second plurality of sliding slats 292 are operable to slide adjacent to the plurality of sliding slats 240 of the sliding seat 204, similar to how the plurality of sliding slats 240 slide with respect to the plurality of fixed slats 230. The second sliding seat 290 may be operable to move independently with respect to the sliding seat 204.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A recreational vehicle comprising:
a body including a cab area and a living space area;
a convertible seat assembly in the living space area, the convertible seat assembly operable to transition between a collapsed position and an expanded position, the convertible seat assembly including:
a fixed seat, and
a sliding seat, the sliding seat being independently moveable with respect to the fixed seat; and
a seat belt assembly coupled to the convertible seat assembly, the seat belt assembly including a first seat belt operable to releasably couple to the fixed seat and a second seat belt operable to releasably couple to the sliding seat.

2. The recreational vehicle of claim 1, wherein the fixed seat and the sliding seat collapse to form a single seat in the collapsed position.

3. The recreational vehicle of claim 1, wherein the first seat belt and the second seat belt are both three-point seat belts.

4. The recreational vehicle of claim 3, wherein a latch of the second seat belt releasably couples to a second buckle in a side-wall of the living space area to establish three-point contact.

5. The recreational vehicle of claim 1, wherein the sliding seat further includes a seat back portion and a seat bottom portion, the seat back portion and the seat bottom portion operable to move independently from each other.

6. The recreational vehicle of claim 1, comprising a first alarm component on the fixed seat, a second alarm component on the sliding seat, and a third alarm component on a side wall adjacent to the sliding seat, wherein an alarm signal is generated when the second alarm component is not in communication with at least one of the first alarm component or the third alarm component.

7. The recreational vehicle of claim 1, wherein the sliding seat is coupled to at least one of a floor of the living space area or a side wall of the living space area when the convertible seat assembly is in the expanded position.

8. The recreational vehicle of claim 7, wherein the sliding seat is coupled to the living space area via at least one release pin that is transitionable between a locked position and an unlocked position.

9. The recreational vehicle of claim 8, wherein the sliding seat further includes a seat back portion and a seat bottom portion and the release pins are positioned on both the seat back portion and the seat bottom portion.

10. The recreational vehicle of claim 8, wherein the release pin includes a lock component to transition the release pin to the locked position, the lock component including a body extending through a frame of the sliding seat and into a housing positioned in the recreational vehicle.

11. The recreational vehicle of claim 8, wherein the release pin includes a release mechanism to transition the release pin to the unlocked position, the release mechanism including a spring.

12. The recreational vehicle of claim 1, wherein the convertible seat assembly is operable to transition to a further expanded position to define a second sliding seat, the second sliding seat including a second plurality of sliding slats, the second sliding seat being adjacent to the sliding seat when the convertible seat assembly is in the further expanded position.

13. The recreational vehicle of claim 1, wherein the fixed seat includes a plurality of fixed slats and the sliding seat includes a plurality of sliding slats, the plurality of sliding slats operable to slide adjacent to the plurality of fixed slats to transition the convertible seat assembly between the collapsed position and the expanded position.

14. The recreational vehicle of claim 1, further comprising a cushion assembly coupled to the convertible seat assembly.

15. The recreational vehicle of claim 1, wherein the collapsible seat assembly has a collapsed width in the collapsed position and an overall expanded width in the expanded position, wherein the expanded overall width is between 90% to 110% of the collapsed width.

16. A convertible seat assembly operable to transition between a collapsed position and an expanded position, the convertible seat assembly comprising:
a fixed seat including a plurality of fixed slats;
a sliding seat including a plurality of sliding slats, the sliding seat being adjacent to the fixed seat when the convertible seat assembly is in the expanded position, wherein the plurality of sliding slats is operable to slide adjacent to the plurality of fixed slats to transition the convertible seat assembly between the collapsed position and the expanded position; and
a seat belt buckle positioned on an end of the fixed seat operable to receive a first three-point seat belt.

17. The convertible seat assembly of claim 16, wherein the fixed seat and the sliding seat collapse to form a single seat in the collapsed position.

18. The convertible seat assembly of claim 16, further comprising a second seat belt buckle positioned on an end of the sliding seat operable to receive a second three-point seat belt.

19. The convertible seat assembly of claim 16, wherein the sliding seat further includes a seat back portion and a seat bottom portion, the seat back portion and the seat bottom portion operable to move independently from each other.

20. The convertible seat assembly of claim 16, wherein the convertible seat assembly is operable to transition to a further expanded position to define a second sliding seat, the second sliding seat including a second plurality of sliding slats, the second sliding seat being adjacent to the sliding seat when the convertible seat assembly is in the further expanded position.
